(19) United States
(12) Patent Application Publication
(10) Pub. No.: US 2020/0258046 A1
(43) Pub. Date: Aug. 13, 2020

(54) AUTOMATED CHAT SYSTEM FOR WEB AND MOBILE

(71) Applicant: PRO Unlimited Global Solutions, Inc., Boca Raton, FL (US)

(72) Inventors: Nataliya Kolb, San Francisco, CA (US); Anant Raman, Pleasanton, CA (US); Ted Sergott, Moraga, CA (US); Shishir Pande, Levittown, CA (US); Nellie LeMonier, Alameda, CA (US); Haihua Huang, Cupertino, CA (US)

(21) Appl. No.: 16/785,457

(22) Filed: Feb. 7, 2020

Related U.S. Application Data
(60) Provisional application No. 62/802,318, filed on Feb. 7, 2019.
(60) Provisional application No. 62/802,320, filed on Feb. 7, 2019.

(51) Int. Cl. G06Q 10/10; G06Q 30/02; G06F 40/205; H04L 12/58

(52) U.S. Cl. CPC G06Q 10/1053; G06Q 10/107; G06N 20/00; G06F 40/205; H04L 51/02; G06Q 30/0201

(57) ABSTRACT

A system and method for automating a request creation that allows interaction with a user comprises at least one communication device in communication with an automated request creation system via a network. The automated request creation system includes a request creation server residing on a central computer having a processor installed with a request creation application and coupled with a memory unit integrated with a central database. The automated request creation system comprises a presentation module, a request module, a processing and parsing module, a mapping module, a rate identification module, a request creation module and a review module at the processor of the central computer. The automated request is created by the request creation module when the user confirms a plurality of data points based on the mapping module and the rate identification module.

### PRIORITY CLAIM

This application claims the benefit of U.S. provisional patent applications 62/802,318 and 62/802,320 as filed Feb. 7, 2019. The disclosure of these provisional applications is incorporated herein as if set out in full.

### TECHNICAL FIELD OF THE DISCLOSURE

The present invention relates generally to automated chat systems, and more specifically to a system and method for automating a request creation process to source for a contingent workforce using a chatbot through text, web, email, messenger and mobile.

### DESCRIPTION OF THE RELATED ART

Recruiters, hiring managers and human resources personnel are often inundated with numerous job applicants or candidates for open positions. Recruiters may spend, for example, forty hours simply screening or narrowing down an initial pool of job candidates to identify a subset of candidates to be interviewed. During the screening process, qualified candidates may due to human error be erroneously removed from an initial pool of candidates, for example. While hiring managers often intend to remove many candidates from such pools due to, among other reasons, lack of qualifications, experience or education, it is also common that hiring managers are overwhelmed with data and thus cannot carefully isolate the most appropriate candidates for a position.

Although recent advancements have allowed for electronically searching candidate resumes or applications, such automated searching may miss other relevant terms and fail to provide more detailed, current, or relevant information about candidates during the screening process. In some cases, search terms found in a candidate's resume or job application may be taken out of context and may not be relevant. For example, a resume may mention a particular skill, but the candidate may not have practiced the skill in many years. In other cases, information about a promising candidate may be missed because of the inability to recognize variations of a particular search term or the inability to ask follow-up questions during the initial screening process, especially when screening a large number of job candidates.

Artificial intelligence (AI) often includes a computer configured to understand a natural language such as English. If a computer can understand and respond to a human in a natural language, the computer provides utility and an intimate level of human interaction that humans appreciate. Accordingly, there is significant interest in developing software and hardware to effectively communicate with humans in a natural language. For example, the Loebner Prize contest, started in 1990 and held annually, is a competition to create a computer that responds to queries in the most human-like manner. Some companies have produced voice-recognition devices that can respond to human queries in a natural language. For example, Alexa®, Apple® computers with Siri®, Watson from IBM®, and computer devices with Google Voice® offer humans the opportunity to ask questions to a computer and receive responses in a natural language.

Computers implementing natural language processing rely on case-based reasoning. Case-based reasoning consists of a large database of queries and stored responses to those queries. When a human asks a computer a question, the computer queries its database for a match to that query, and, if it finds one, responds with a prepacked, associated response. By having a large enough database or access to one, such computers can become powerful tools. For example, computers implementing English-to-French or French-to-English translation rely on the Hansard Corpus database, which consists of parallel texts in English and Canadian French, drawn from official records of the proceedings of the Parliament of Canada. In such an example, the computers train with the Hansard Corpus database to become “intelligent” enough to answer human voice queries to translate from French to English or vice versa.

Although natural language processing and case-based reasoning are significantly developed fields that provide AI, computers still lack the ability to assist humans in many areas of AI. For example, humans could benefit from having the ability to communicate with proprietary computer systems, database management systems, or custom devices, and while a human may query these devices using a natural language, these devices cannot always understand the request.

A paradigm of this translation problem exists in database management software. Database management software creates, retrieves, updates, backs up, and manages large quantities of data. Because database management software generally has its own language (e.g., query structure, syntax, vocabulary), it is difficult to use natural language processing to enable humans to interact with database management software, even with voice-recognition software. This is particularly true in complex fields such as recruitment.

A computer generally builds a vocabulary for a custom model by extracting terms from corpora or other sources that do not exist in its base vocabulary. To improve accuracy, a computer should access as many examples as possible of how custom words are used in the domain. The more sentences that represent the context in which speakers use words from the domain, the better the accuracy.

Based on at least the lack of hardware, software, phone systems, online systems, and corpora, users often find themselves frustrated with systems that fail to interact with database management software to produce the desired responses or answers. Accordingly, there exists a need to solve at least these problems and provide additional advantages. This is particularly true in the field of recruitment, where recruiters, hiring managers and human resources personnel are often inundated with numerous job applicants, data and/or candidates for an open position, often using a mix of natural language data points as described above.

There is thus a need for a system and method for automating a request creation process to source for a contingent workforce. Such a system and method would allow interaction with a user to receive a plurality of data points for the creation of a request with clarity. Such a system would display a plurality of queries in a user friendly manner so as in return receive a plurality of data points. Such an automated request creation system would utilize a combination of natural language parsing, self-learning and artificial intelligence to parse and process the plurality of data points to enhance efficiency. Such a system and method would allow processing and parsing the plurality of data points into user specific configurations and to be stored in client-specific databases, to present with a variety of options for analysis and selection by the user. Such a needed system and method would identify the market rates algorithmically for each of the plurality of data points for analysis and confirmation by the user. Such a system and method would review the user specific configurations based on the plurality of data points before sending the automated request. Such a system and method would provide updates about a plurality of actions to be taken by the user within a period of time. The present embodiment overcomes shortcomings in the field by accomplishing these critical objectives.

### SUMMARY OF THE DISCLOSURE

To minimize the limitations found in the existing systems and methods, and to minimize other limitations that will be apparent upon the reading of this specification, a preferred embodiment of the present invention provides a system for automating a request creation that allows interaction with a user to receive necessary details to create a request with clarity.

The system for automating the request creation comprises at least one communication device in communication with an automated request creation system via a network. The automated request creation system includes a request creation server residing on a central computer having a processor installed with a request creation application and coupled with a memory unit integrated with a central database. The automated request creation system comprises a presentation module, a request module, a processing and parsing module, a mapping module, a rate identification module, a request creation module and a review module at the processor of the central computer. The presentation module is configured to present a messaging window on the at least one communication device for the user interactions. The request module is configured to provide a plurality of queries on the messaging window in a user friendly manner to request a plurality of data points. The plurality of data points can include, for example, the job title, the location, the start date and the end date of a job request or a hiring request. The at least one communication device is configured to allow the user to provide the plurality of data points including the job title, the location, the start date and the end date via the network. The plurality of queries is presented in a natural language for the user to understand and to provide the answers with clarity. The processing and parsing module receives the plurality of data points from the request module and processes and parses the plurality of data points into user specific configurations which are then stored in client-specific databases. The mapping module is configured to provide a plurality of options on the messaging window for selection by the user if multiple matches for the user provided data points are available. The mapping module also provides updates about the plurality of actions to be taken by the user within a period of time. The rate identification module is configured to identify the market rates algorithmically for each of the plurality of data points provided by the user. The rate identification module then displays the market rates on the messaging window and waits for the user confirmation. Once the user confirms the plurality of data points, the request creation module creates an automated request based on the confirmed data points. The review module checks if the automated request created is based on the user specific configurations from the plurality of data points confirmed by the user, before sending the automated request. Thus, the automated request is created by the request creation module when the user confirms the plurality of data points based on the mapping module and the rate identification module. The at least one communication device is selected from a group consisting of: a cellular telephone, a smartphone, a wireless-enabled personal digital assistant, a tablet, a personal computer, a notebook and a mobile device.

A method for automating the request creation utilizing the automated request creation system comprises the steps of: providing the request creation application installed in the automated request creation system which is in communication with the at least one communication device via the network. Providing the messaging window on the at least one communication device by the presentation module to interact with the user, by displaying the plurality of queries on the messaging window in a user-friendly manner by the request module to receive the plurality of data points. Then, processing and parsing the plurality of data points into user specific configurations and storing in client-specific databases by the processing and parsing module. Thereafter, providing a plurality of options on the messaging window for selection by the user by the mapping module if multiple matches for the user provided data points are available. Next, identifying the market rates algorithmically for each of the plurality of data points by the rate identification module for analysis and confirmation by the user. Finally, creating the automated request once the user confirms the plurality of data points by the request creation module and reviewing the user specific configurations based on the plurality of data points before sending the automated request by the review module.

In one embodiment of the system for automating the request creation, the plurality of data points can be collected via an email interface. In this embodiment, the user is provided with an email id and the plurality of queries for collecting the plurality of data points are emailed to the user. In this embodiment, the user provides the plurality of data points by replying to the queries via the provided email id.

A first objective of the present embodiment is to provide a system and method for automating a request creation process to source for a contingent workforce.

A second objective of the present embodiment is to provide a system and method that allows interaction with a user to receive a plurality of data points for the creation of request with clarity.

A third objective of the present embodiment is to provide a system and method that displays a plurality of queries in a user friendly manner to receive the plurality of data points.

A fourth objective of the present embodiment is to provide an automated request creation system that utilizes a combination of natural language parsing, self-learning and artificial intelligence to parse and process the plurality of data points to enhance efficiency.

A fifth objective of the present embodiment is to provide a system and method that allows processing and parsing the plurality of data points into user specific configurations and to be stored in client-specific databases, to present with a variety of options for analysis and selection by the user.

Another objective of the present embodiment is to provide a system and method that identifies the market rates algorithmically for each of the plurality of data points for analysis and confirmation by the user.

Yet another objective of the present embodiment is to provide a system and method that reviews the user specific configurations based on the plurality of data points before sending the automated request.

Still another objective of the present embodiment is to provide a system and method that can be utilized for creating both job request and hiring request.

Still another objective of the present embodiment is to provide a system and method that provides updates about a plurality of actions to be taken by the user within a period of time.

These and other advantages and features of the present invention are described with specificity so as to make the present invention understandable to one of ordinary skill in the art.

### BRIEF DESCRIPTION OF THE DRAWINGS

In order to enhance their clarity and improve the understanding of the various elements and embodiment, elements in the figures have not necessarily been drawn to scale. Furthermore, elements that are known to be common and well understood to those in the industry are not depicted in order to provide a clear view of the various embodiments of the invention. Thus, the drawings are generalized in form in the interest of clarity and conciseness.

FIG. 1 illustrates a block diagram of a system for automating a request creation in accordance with the preferred embodiment of the present invention;

FIG. 2 is a screenshot of a messaging window for receiving a plurality of data points in accordance with the preferred embodiment of the present invention; and

FIG. 3 illustrates a flowchart of a method for automating the request creation utilizing an automated request creation system in accordance with the preferred embodiment of the present invention;

FIG. 4 is a screenshot of the messaging window which illustrates an example of extending the end date of an employee in accordance with the preferred embodiment of the present invention;

FIG. 5 is a screenshot of the messaging window which illustrates an example of terminating the employee in accordance with the preferred embodiment of the present invention;

FIGS. 6A-6B are the screenshots of the messaging window which illustrates an example of a staffing request creation via an email interface in accordance with one embodiment of the present invention;

FIG. 7 is a screenshot of the messaging window which illustrates an example of providing updates on a plurality of actions to be taken via the email interface in accordance with one embodiment of the present invention;

FIG. 8A is a screenshot of the messaging window which illustrates an example of providing the summary of the activities performed by the user and the upcoming end dates for the plurality of request created via the email interface in accordance with one embodiment of the present invention;

FIG. 8B is a screenshot of the messaging window which illustrates an example of providing details about the market rates, the total head counts in different job title, the number of open requests in different job titles and the overtime hours to the user via the email interface in accordance with one embodiment of the present invention; and

FIGS. 9A-9E is a control flow diagram of the system for automating the request creation which illustrates an example of extending the end date of the employee and terminating the employee in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

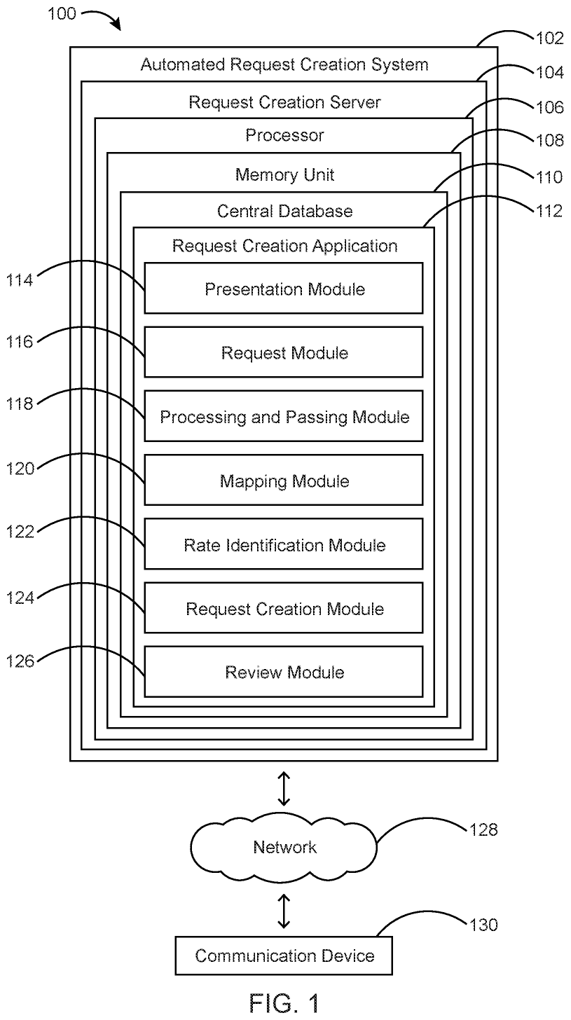

Referring to FIG. 1, a block diagram of a system 100 for automating a request creation in accordance with the preferred embodiment of the present invention is illustrated. The present system 100 allows interaction with a user to receive the necessary details to create a request with clarity.

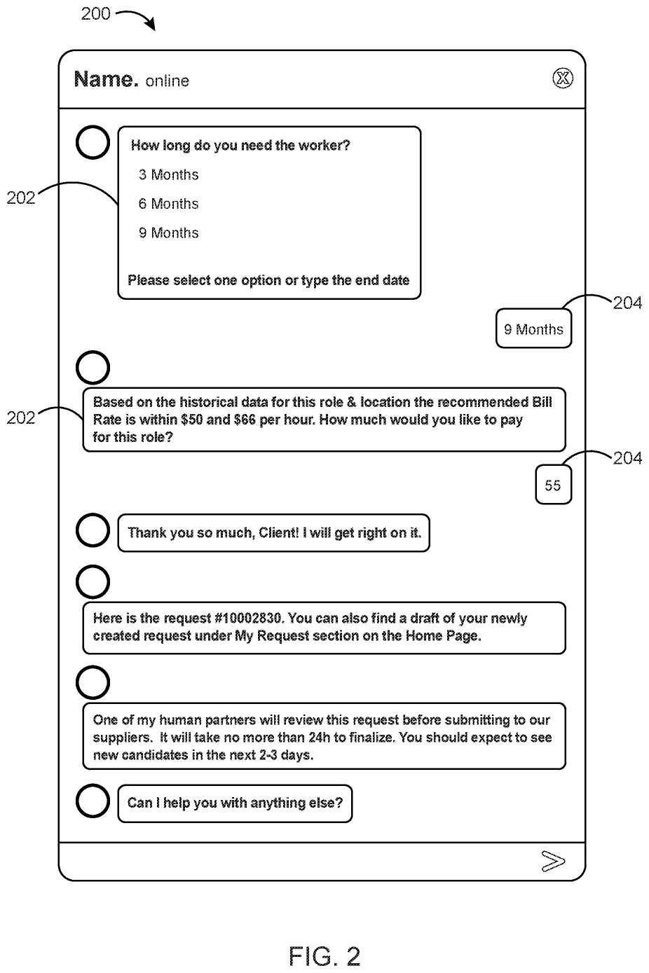

The system 100 for automating the request creation comprises at least one communication device 130 in communication with an automated request creation system 102 via a network 128. The automated request creation system 102 includes a request creation server 104 residing on a central computer (not shown) having a processor 106 installed with a request creation application 112 and coupled with a memory unit 108 integrated with a central database 110. The automated request creation system 102 comprises a presentation module 114, a request module 116, a processing and parsing module 118, a mapping module 120, a rate identification module 122, a request creation module 124 and a review module 126 at the processor 106 of the automated request creation system 102. The presentation module 114 is configured to present with a messaging window 200 (see FIG. 2) on the at least one communication device 130 for the user interactions. The request module 116 is configured to provide a plurality of queries 202 (see FIG. 2) on the messaging window 200 (see FIG. 2) in a user friendly manner to request a plurality of data points 204 (see FIG. 2). The plurality of data points 204 can include, for example, the job title, the location, the start date and the end date of a job request or a hiring request.

The at least one communication device 130 is configured to allow the user to provide the plurality of data points 204 including the job title, the location, the start date and the end date to the automated request creation system 102 via the network 128. The plurality of queries 202 is presented in a natural language for the user to understand and to provide the answers with clarity. These answers are taken as the plurality of data points 204. Thus, the request module 116 allows interacting with the user and receiving any missed out details for creating the request. The processing and parsing module 118 receives the plurality of data points 204 from the request module 116 and process and parse the plurality of data points 204 into user specific configurations which are then stored in client-specific databases. The processing and parsing module 118 utilizes a combination of natural language parsing, self-learning and artificial intelligence to parse and process the plurality of data points 204. The plurality of data points 204 is processed using machine learning and natural language parsing to enhance clarity and efficiency of the user interactions.

The mapping module 120 is configured to provide a plurality of options (not shown) on the messaging window 200 for selection by the user if multiple matches for the user provided data points 204 are available. For example, if the user has provided a set of data points 204 to the automated request creation system 102 through the messaging window 200, the mapping module 120 checks if different options for the given set of data points 204 are available. If different options are available, the automated request creation system 102 will display the available different options on the messaging window 200 for the user to select based on which the request is to be created.

Further, the mapping module 120 is configured to provide updates on a plurality of actions to be taken by the user within a period of time. The plurality of actions can include, for example, extending the end date of an employee, terminating an employee, canceling a hiring request after the end date, confirming an end date etc. For example, a hiring manager can get updates about the actions to be taken within a particular period. In this example, the automated request creation system 102 provides updates on, for example, an end date of a particular employee so that the manager can either accept or extend the end date of that particular employ. Thus, the mapping module 120 provides alert on various actions to be taken by the user.

The rate identification module 122 is configured to identify the market rates algorithmically for each of the plurality of data points 204 provided by the user. The rate identification module 122 then displays the market rates on the messaging window 200 and waits for the user confirmation. Thus, the rate identification module 122 allows analysis of market rates and request confirmation by the user.

Once the user confirms the plurality of data points 204, the request creation module 124 creates an automated request based on the confirmed set of data points 204. Before sending the automated request, the review module 126 checks if the automated request created is based on the user specific configurations from the plurality of data points 204 confirmed by the user. Thus, the automated request is created by the request creation module 124 when the user confirms the plurality of data points 204 based on the mapping module 120 and the rate identification module 122. The automated request created can be a job request or a hiring request. If the user is a job seeker, a job request is automatically created by the automated request creation system 102 and if the user is a hiring manager, a hiring request is created based on the plurality of data points 204 provided to the system 100. Thus, the system 100 of the present invention allows interaction with the user that enables to receive any missed data points, based on which the automated request is created with clarity.

FIG. 2 is a screenshot of the messaging window 200 for receiving the plurality of data points 204. The messaging window 200 of FIG. 2 illustrates an example with the plurality of queries 202 for receiving the plurality of data points 204 for creating a hiring request. In this example, the automated request creation application 112 allows interaction with the hiring manager to get necessary details like for how long he needs a worker and also based on the recommended rates how much he can pay for the worker. Based on these data, the automated request is created. The system 100 allows reviewing the request before posting the created request. The messaging window 200 can be displayed in a web or mobile interface.

The at least one communication device 130 is selected from a group consisting of: a cellular telephone, a smartphone, a wireless-enabled personal digital assistant, a tablet, a personal computer, a notebook and a mobile device.

In the preferred embodiment, when the automated request needs to be created, the request creation application 112 presents the plurality of queries 202 on the messaging window 200. The user enters the plurality of data points 204 based on the plurality of queries 202 which are then processed and parsed into user specific configurations and stored in client-specific databases. If different options are available for a given set of data points 204, the request creation application 112 provides the user with the plurality of options for selection and confirmation. Then the automated request is created when the user confirms a set of data points 204. The automated request thus created is reviewed before sending the created automated request.

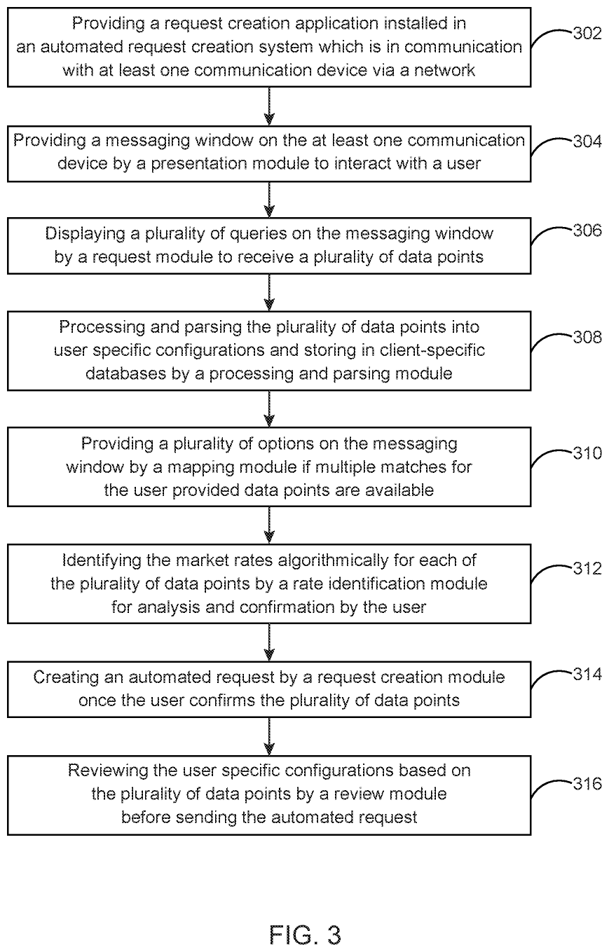

FIG. 3 illustrates a flowchart of a method for automating a request creation utilizing an automated request creation system in accordance with the preferred embodiment of the present invention. The method comprises the steps of: providing a request creation application installed in an automated request creation system which is in communication with at least one communication device via a network as indicated at block 302; providing a messaging window on the at least one communication device by a presentation module to interact with a user as indicated at block 304; displaying a plurality of queries on the messaging window in a user friendly manner by a request module to receive a plurality of data points as indicated at block 306; then processing and parsing the plurality of data points into user specific configurations and storing in client-specific databases by a processing and parsing module as indicated at block 308; providing a plurality of options on the messaging window for selection by the user by a mapping module if multiple matches for the user provided data points are available as indicated at block 310; then identifying the market rates algorithmically for each of the plurality of data points by a rate identification module for analysis and confirmation by the user as indicated at block 312; creating an automated request once the user confirms the plurality of data points by a request creation module as indicated at block 314 and reviewing the user specific configurations based on the plurality of data points before sending the automated request by a review module as indicated at block 316.

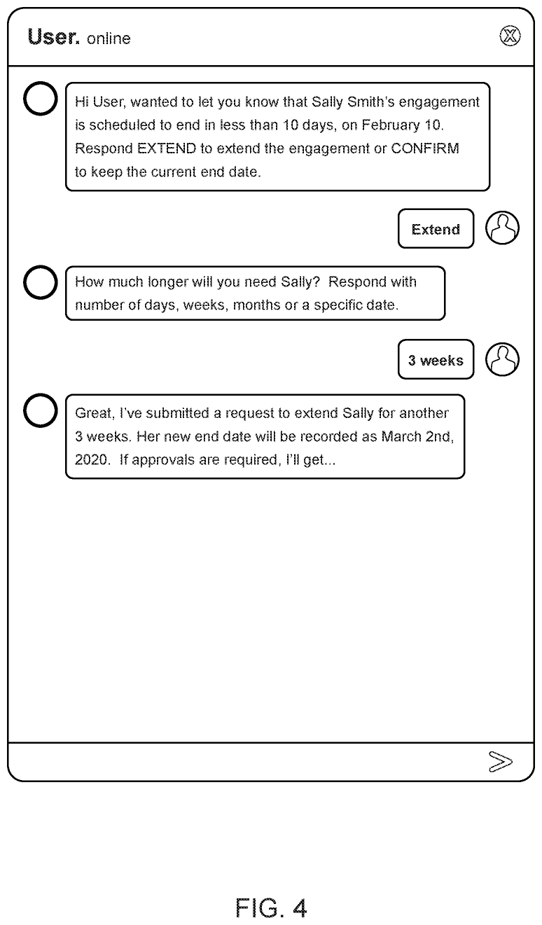

FIG. 4 is a screenshot of the messaging window which illustrates an example of extending the end date of an employee in accordance with the preferred embodiment of the present invention. The example of FIG. 4 illustrates a manager extending the end date of the employee utilizing the automated request creation system in a mobile interface. The automated request creation application interacts with the manager by providing the plurality of queries to the manager as illustrated in FIG. 4. In this example, initially the system provides an update to the manager about the scheduled end date of the particular employee and about the number of days left before the end date. This update is provided by the system before the actual end date. The system further provides options to the manager either to extend the end date of the employee or to confirm to keep the current end date. As illustrated in this example, if the manager wants to extend the end date of the employee, the system further put forward queries on how long the manager wants to extend the end date. This can be provided to the system in terms of the number of days, weeks, months or a specific date. Once the system receives the correct date, an updated automated request is created by the automated request creation system with the new confirmed end date. Thus, in this example, the interaction with the manager allows to create the request with clarity.

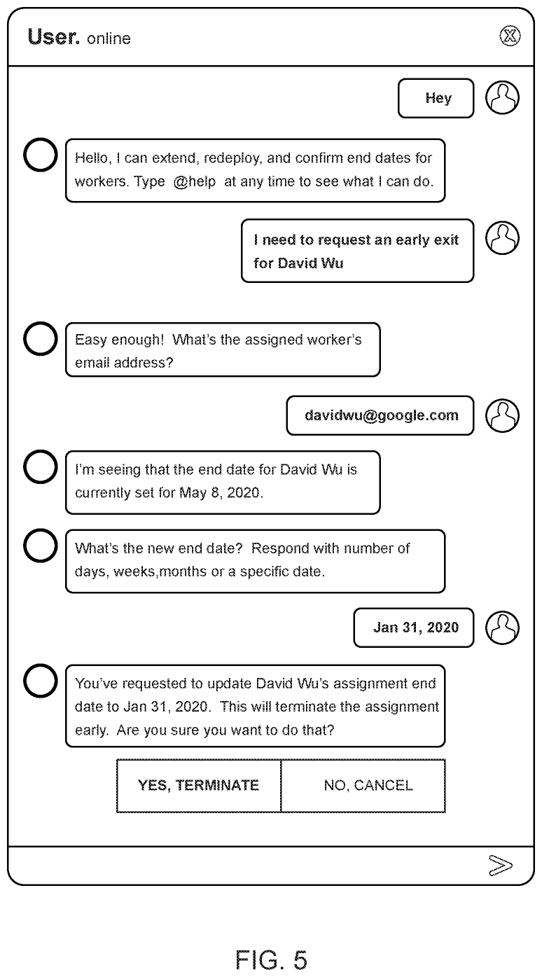

FIG. 5 is a screenshot of the messaging window which illustrates an example of terminating the employee in accordance with the preferred embodiment of the present invention. This example illustrates a manager terminating the employee before the actual end date of the employee. The automated request creation application provides the plurality of customized queries to get the data points from the manager. Once the manager login to the system, the system provides a plurality of actions from which the manager can select what needs to be done. In this example, the plurality of actions includes extend, redeploy and confirm the end date of the employee. The manager interacts with the system for an early exit for the employee. The system then asks for the email id of the employee for contacting the employee. Once the manager provides the email id, the system informs about the actual end date of the employee and asks for the new end date. The manager can provide the new end date as number of days, weeks, months or a specific date. As the manager provides the new end date, the system asks the manager to confirm the new end date, based on which an automated request is created to terminate the employee before the actual end date.

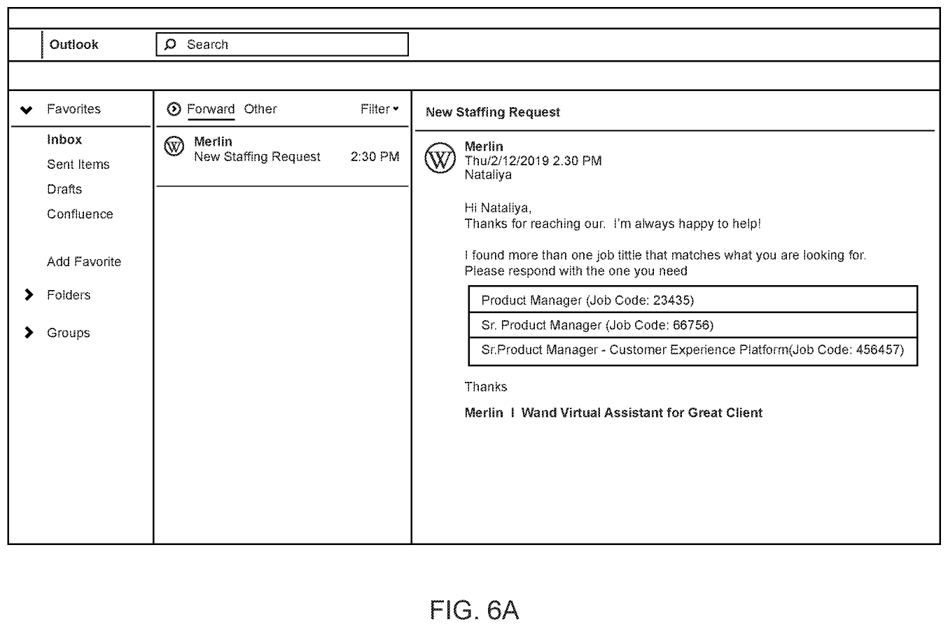

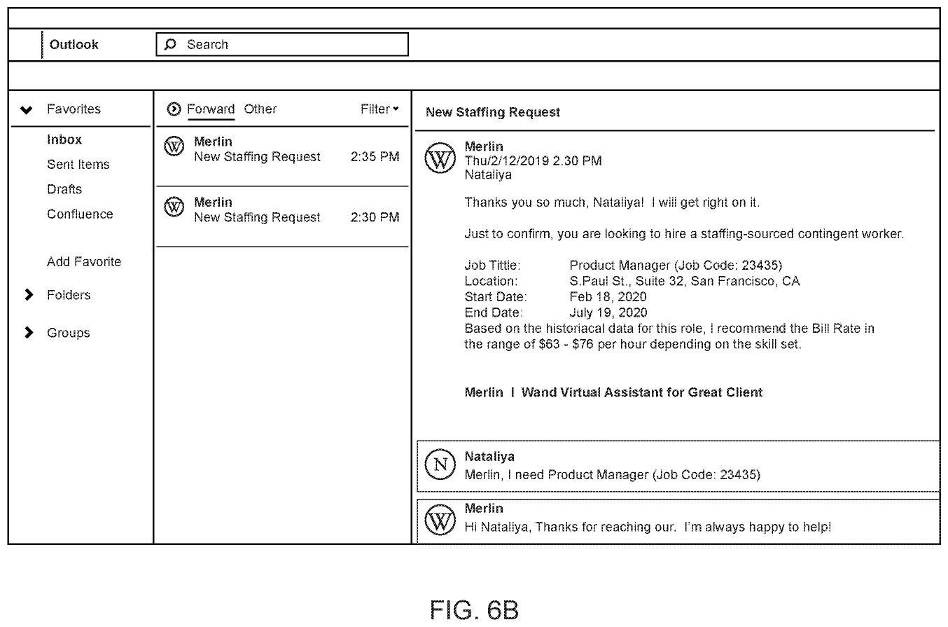

FIGS. 6A-6B are the screenshots of the messaging window which illustrates an example of a staffing request creation via an email interface in accordance with one embodiment of the present invention. In this embodiment, the plurality of data points is collected via the email interface. For example, a staffing request is created by the automated request creation system by interacting with the manager via an email id. The plurality of queries is provided to the manager and the plurality of data points are collected via the email interface. The system come across a plurality of options for the manager provided data points which are provided for selection by the manager. Once the manager selects a particular option, the rate identification module provides the market rates algorithmically for the selected option by the manager. The system then creates the staffing request based on the plurality of data points provided by the manager. Thus, in this embodiment, all interactions with the manager is done through the email interface.

In one embodiment of the automated request creation system 102, the plurality of data points is received via an email interface. In this embodiment, the user interacts with the automated request creation application 112 using an email id. The system provides the plurality of queries to the user via the email interface and gets back the plurality of data points through the email interface. The mapping module provides the plurality of options on the email interface for selection by the user if multiple matches for the user provided data points are available and the rate identification module provides the market rates algorithmically for the data points provided by the user through the email id for confirmation. The new automated request is created based on the interactions with the user through the email interface.

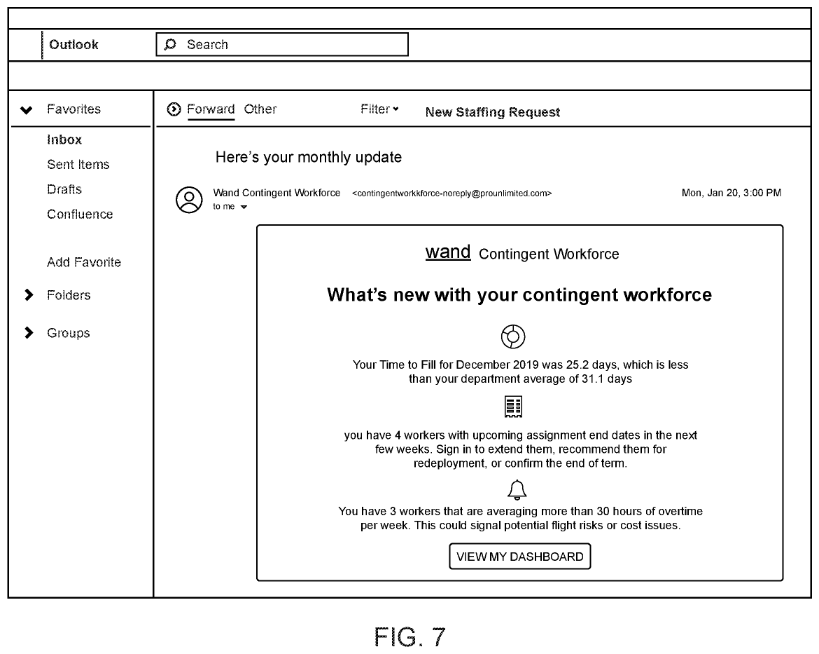

FIG. 7 is a screenshot of the messaging window which illustrates an example of providing updates on a plurality of actions to be taken via the email interface in accordance with one embodiment of the present invention. In this embodiment of the automated request creation system 102, the mapping module provides updates on the plurality of actions to be taken within a period of time. These updates can be provided to the user through the web, mobile or email interface. This embodiment acts as an alert and allows the user to check and update the request before the end date.

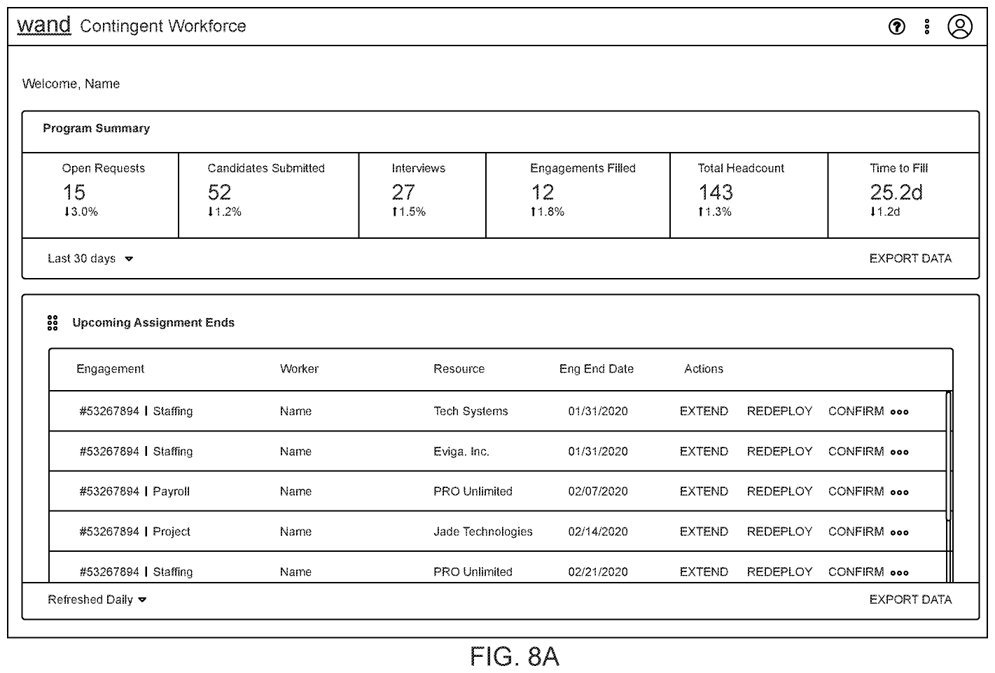

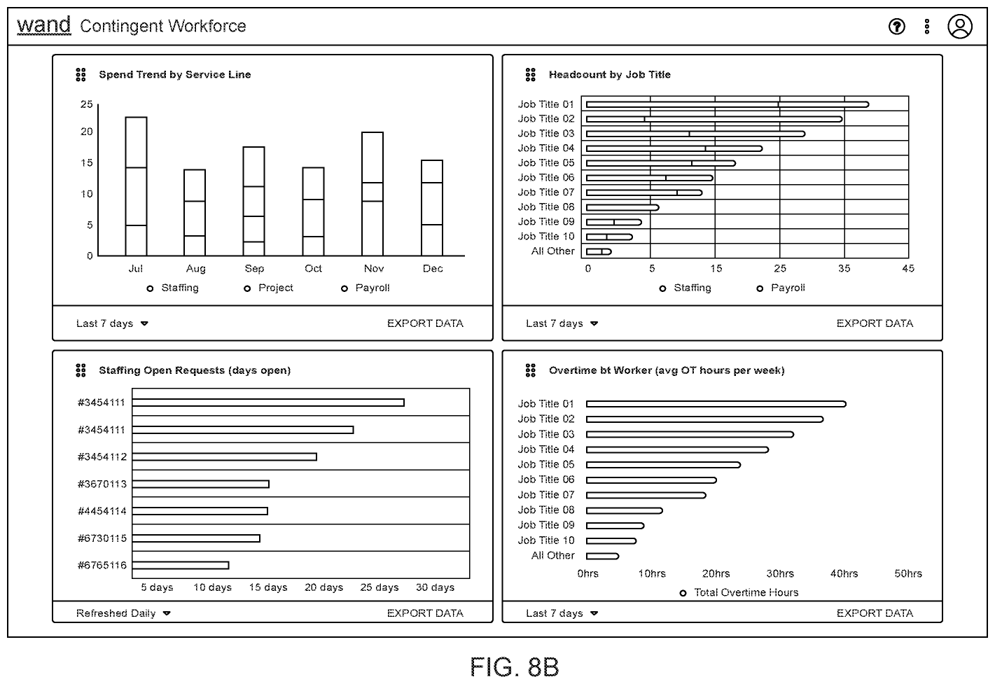

FIG. 8A is a screenshot of the messaging window which illustrates an example of providing the summary of the activities done by the user and the upcoming end dates for the plurality of requests created via the email interface in accordance with one embodiment of the present invention. In one embodiment, the automated request creation system 102 provides the summary of the activities carried out by the user while hiring a work force. In this embodiment, the system provides details about the total open request created by the user, the number of candidates who submitted the provided request, the number of interviews held, the number of engagements filled, the total number of head counts and the remaining time for closing or updating the request. This embodiment allows the user to know about the overall activities carried out for hiring a work force utilizing the automated request creation system 102.

In one embodiment, the automated request creation system 102 provides details about the upcoming end dates for various open requests, the worker and the resource associated with the respective open request. This embodiment functions as an alert for the user to know about the nearby end dates, the worker and the resource associated with the request and also provide options to update the requests nearing the end dates. The system allows extending, redeploying or confirming the end dates for the request.

FIG. 8B is a screenshot of the messaging window which illustrates an example of providing details about the market rates, the total head counts in different job title, the number of open requests in different job titles and the overtime hours to the user via the email interface in accordance with one embodiment of the present invention. In one embodiment, the automated request creation system 102 provides details about the market rates algorithmically for a particular project and the number of staffs engaged in that project. This embodiment allows analysis of market rates for different months for the project. This embodiment provides details about the number of staffs, the project and the payroll for different months to know the market rates.

In one embodiment, the automated request creation system 102 provides details about the total head counts in different job title and the payroll for the different job titles. This embodiment allows the user to know about the number of employees working in each department and about the money spent on each department.

In one embodiment, the automated request creation system 102 provides details about the number of open requests in different job titles and the days left for the open request. This embodiment allows the user to know the open request for each job title and the remaining days available to keep the request open.

In one embodiment, the automated request creation system 102 provides details about the overtime hours which different employees took in a week. This embodiment allows the user to view the total overtime hours each employee took in a week.

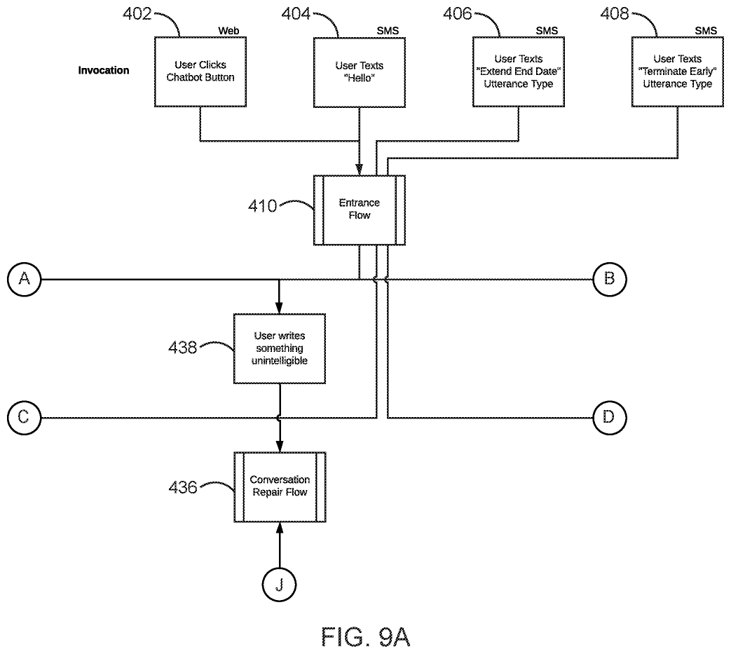

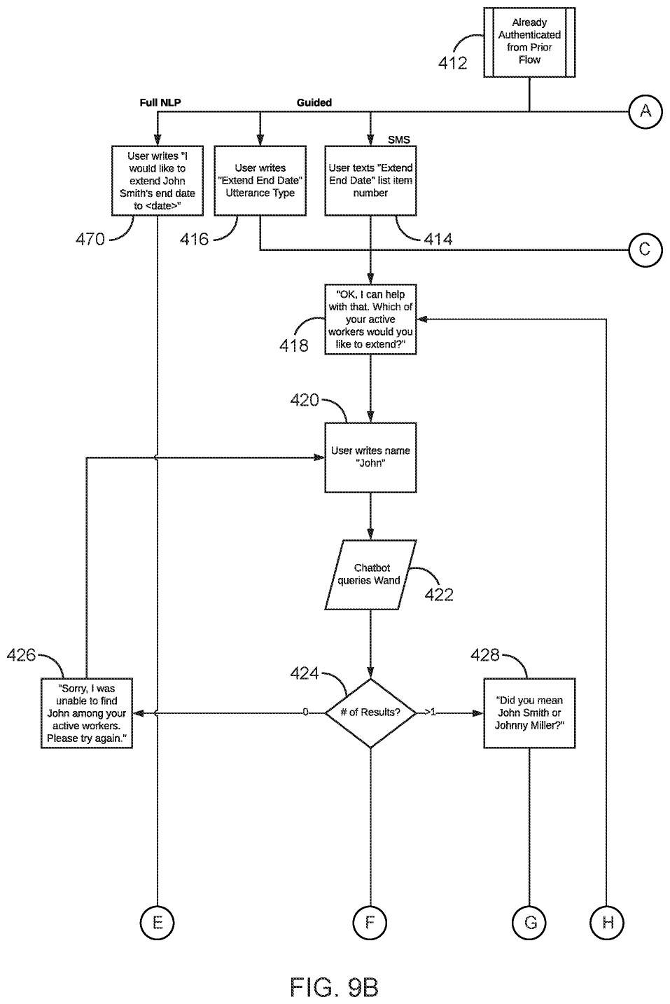

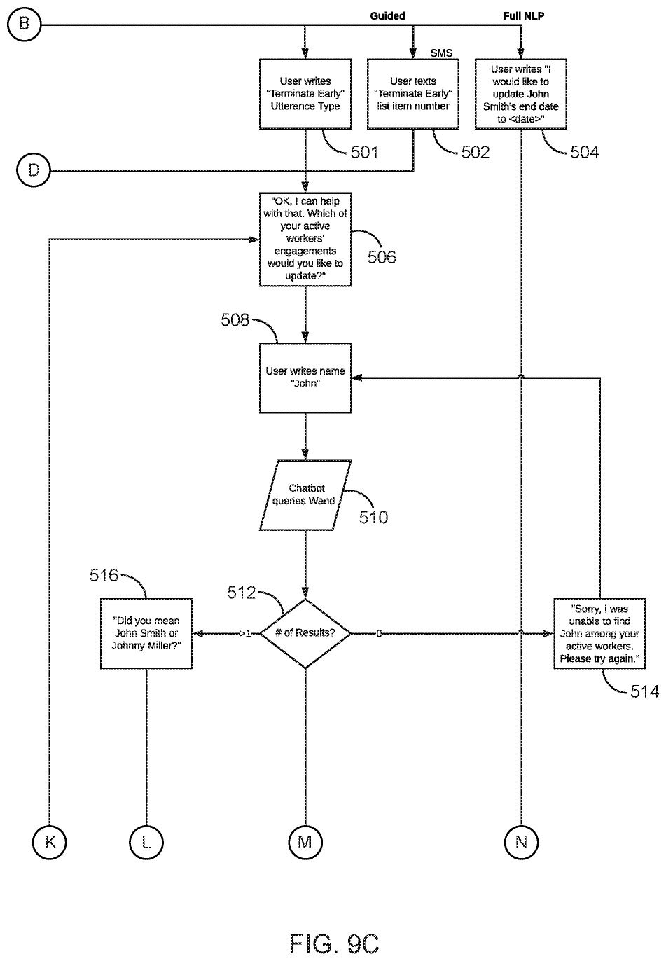

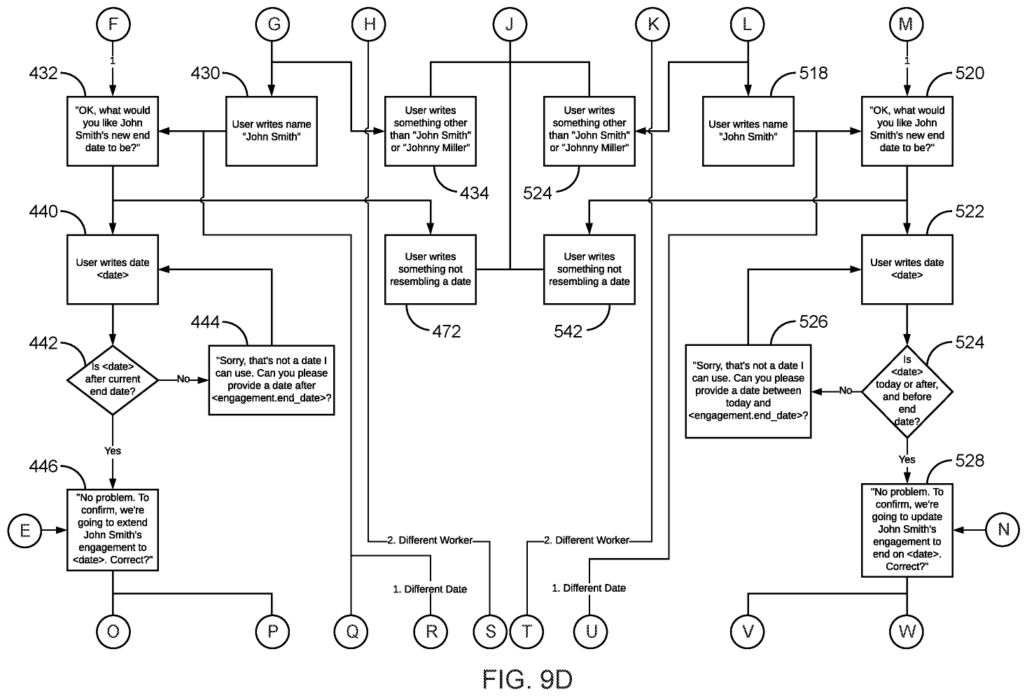

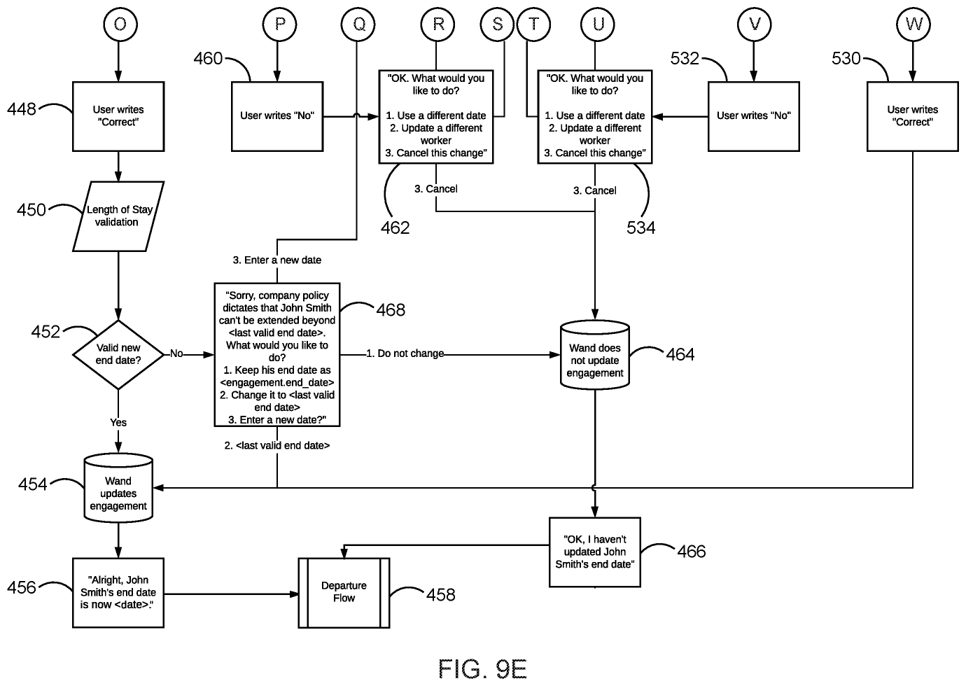

FIGS. 9A-9E is a control flow diagram of the system for automating the request creation which illustrates an example of extending the end date of the employee and terminating the employee in accordance with the preferred embodiment of the present invention. In this example, the user can preferably be the manager who has the rights to extend the end date of the employee or to terminate the employee. The user can login to the automated request creation system through the web, mobile or email interface. In the control flow diagram of the present example, the user login to the automated request creation system through the web or mobile interface. The user may be provided with a login id or an email id for logging into the system (Chatbot). The user can invoke the automated request creation system by clicking on the application button provided on the web page as indicated in block 402 or by texting a “Hello” message via a mobile interface 404. In one embodiment, the user can directly provide a voice message to the system like “Extend the end date” as indicated in block 406 or a voice message like “Terminate early” as indicated in block 408. In this embodiment, the processing and parsing module of the system can convert the voice message into text message to invoke the system. Once the system is invoked, the authenticated users are checked by the entrance flow as indicated in block 410 and allowed to interact with the system. The authenticated users who are already logged into the system can also interact with the system as indicated in block 412. The present embodiment allows the user to interact with the system in simple natural language as the processing and parsing module converts these into user specific configurations. In this example, the authenticated user can enter the text like “Extend end date” as indicated in block 414 or can give voice message like “Extend end date” as indicated in block 416. The user can also provide a message like “I would like to extend John Smith's end date to <date>” as indicated in block 470. The request from the user from block 414 and block 416 is provided to the system which in turn put forward a query like “OK, I can help with that. Which of your active workers would you like to extend?” as indicated in block 418. The user then interacts with the system by providing the name of the worker as indicated in block 420. For example, the user provides the name of the worker as “John” as indicated in block 420. The data provided by the user is taken by the system as indicated in block 422 and the system checks if the worker with the given name is present as indicated in block 424. If there is no worker with the name “John”, the system displays a message “Sorry, I was unable to find John among your active workers. Please try again.” As indicated in block 426. The control then returns to block 420 and the user needs to enter the name of the worker again. After checking for the worker named “John” as indicated in block 424, if there are more people with the name “John”, the system puts forward a query like “Did you mean John Smith or Johnny Miller?” as indicated in 428. The user then confirms the name as “John Smith” as indicated in block 430. Once confirmation is received from the user, the system then queries “OK, what would you like John Smith's new end date to be?” as indicated in block 432. If only “John Smith” is retrieved after checking for the worker named “John” in block 424, the control transfers to block 432 and asks the user to enter the new end date as indicated in block 432. If the user entered an incorrect name as indicated in block 434, the control is transferred to the conversation repair flow as indicated in block 436. After the login through the entrance flow as indicated in block 410 if the user enters something unintelligible as indicated at block 438, the control is transferred to the conversation repair flow as indicated in block 436. If the user enters something not resembling a date as indicated in block 472, the control is transferred to block 436.

The system asks the user to enter the new end date as indicated in 432 and the user enters a new end date as indicated in block 440. The system then checks if the new date is after the current end date as indicated in block 442. If the date is not correct, the system displays a message “Sorry, that's not a date I can use. Can you please provide a date after <engagementend_date>?” as indicated in block 444 and allows the user to enter the new end date as indicated in block 440. If the end date provided by the user is correct, the system asks to confirm the new end date by displaying a message “No problem. To confirm, we're going to extend John Smith's engagement to <date>. Correct?” as indicated in block 446.

In block 470, the user requested to change the end date of John Smith to a new end date provided in block 470. The control of the system is transferred to block 446 for the user to confirm the new end date provided.

When the user confirms the new end date as indicated in block 448, the system calculates the length of stay of the user as indicated in block 450 and checks the validity of the new end date as indicated in block 452. If the new end date is valid, the system stores the new end date in the database as indicated in block 454 and displays a message to the user as “Alright, John Smith's end date is now <date>.” as indicated in block 456 and the user can exit the system from the departure block as indicated in block 458. If the end date provided by the user is correct, as indicated in block 460, the system displays a message “OK. What would you like to do? 1. Use a different date 2. Update a different worker 3. Cancel this change” as indicated in block 462. If the user wants to provide a different date by pressing 1, the control is transferred to block 432. If the user wants to update a different worker by pressing 2, the control is transferred to block 418 and if the user wants to cancel the change by pressing 3, the system does not update the database as indicated in block 464 and displays the message “OK, I haven't updated John Smith's end date” as indicated in block 466 and the user exits the system from the block 458.

At block 452, if the new date is not valid, the system displays a message like “Sorry, company policy dictates that John Smith can't be extended beyond <last valid end date>. What would you like to do? 1. Keep his end date as <engagement.end_date>2. Change it to <last valid end date>3. Enter a new date?” as indicated in block 468. If the user does not want a change in date by pressing 1, the control is transferred to block 466, if the user wants to change to a valid end date the control is transferred to block 454 and if the user wants to enter a new date, the control is transferred to block 418.

After logging in to the system through the entrance flow as indicated in block 410, if the user wants to terminate an employee earlier than the last end date, the user can give voice message like “Terminate Early” as indicated in block 500 or the user can enter the text like “Terminate Early” as indicated in block 502 or the user can directly request to change the end date of the employee by a message like “I would like to update John Smith's end date to <date>” as indicated in block 504. The request from the user from block 500 and block 502 is provided to the system which in turn put forward a query like “OK, I can help with that. Which of your active workers' engagements would you like to update?” as indicated in block 506. The user then interacts with the system by providing the name of the worker as indicated in block 508. For example, the user provides the name of the worker as “John” as indicated in block 508. The data provided by the user is taken by the system as indicated in block 510 and the system checks if the worker with the given name is present indicated in block 512. If there is no worker with the name “John” the system displays a message “Sorry, I was unable to find John among your active workers. Please try again.” indicated in block 514. The control then returns to block 508 and the user needs to enter the name of the worker again. After checking for the worker named “John” as indicated in block 512, if there are more people with the name “John”, the system puts forward a query like “Did you mean John Smith or Johnny Miller?” as indicated in 516. The user then confirms the name as “John Smith” as indicated in block 518. Once confirmation is received from the user, the system then queries “OK, what would you like John Smith's new end date to be?” as indicated in block 520. If only “John Smith” is retrieved after checking for the worker named “John” in block 520, the control transfers to block 522 and asks the user to enter the new end date as indicated in 522. If the user entered an incorrect name as indicated in block 524 the control is transferred to the conversation repair flow as indicated in block 436. If the user enters something not resembling a date as indicated in block 542, the control is transferred to block 436.

The system asks the user to enter the new end date as indicated in 520 and the user enters a new end date as indicated in block 522. The system then checks if the new date is after the current end date as indicated in block 524. If the date is not correct, the system displays a message “Sorry, that's not a date I can use. Can you please provide a date after <engagementend_date>?” as indicated in block 526 and allows the user to enter the new end date as indicated in block 522. If the end date provided by the user is correct, the system asks to confirm the new end date by displaying a message “No problem. To confirm, we're going to extend John Smith's engagement to <date>. Correct?” as indicated in block 528.

The user can directly request to change the end date of the employee by a message like “I would like to update John Smith's end date to <date>” as indicated in block 504. The control is transferred to the block 528.

When the user confirms the new end date as indicated in block 530, the system stores the new end date in the database as indicated in block 454 and display a message to the user as “Alright, John Smith's end date is now <date>.” as indicated in block 456 and the user can exit the system from the departure block as indicated in block 458. If the end date provided by the user is correct, as indicated in block 532, the system displays a message “OK. What would you like to do? 1. Use a different date 2. Update a different worker 3. Cancel this change” as indicated in block 534. If the user wants to provide a different date by pressing 1, the control is transferred to block 520. If the user wants to update a different worker by pressing 2, the control is transferred to block 506 and if the user wants to cancel the change by pressing 3, the system does not update the database as indicated in block 464 and displays the message “OK, I haven't updated John Smith's end date” as indicated in block 466 and the user exit the system from block 458.

The processor 106 is an electronic circuit that executes computer programs. The memory unit 108 stores programs, applications, and data. For example, the presentation module 114, the request module 116, the processing and parsing module 118, the mapping module 120, the rate identification module 122, the request creation module 124 and the review module 126 of the request creation application 112 are stored on the memory unit 108 of the automated request creation system 102. The memory unit 108 is, for example, a random access memory (RAM) or another type of dynamic storage device that stores information and instructions for execution by the processor 106. The memory unit 108 also stores temporary variables and other intermediate information used during execution of the instructions by the processor 106. The automated request creation system 102 further comprises a read only memory (ROM) or another type of static storage device that stores static information and instructions for the processor 106. The automated request creation system 102 that executes the request creation application 112 communicates with the at least one communication device 130 through the network 128. The network 128 is, for example, a local area network (LAN), a wide area network (WAN), a mobile communication network, a signaling system number 7 (SS7) network, a wired telephony network, any generic data network, etc.

The automated request creation system 102 employs an operating system (not shown) for performing multiple tasks. The operating system (not shown) is responsible for management and coordination of activities and sharing of resources of the automated request creation system 102. The operating system further manages security of the automated request creation system 102, peripheral devices connected to the automated request creation system 102, and network connections. The operating system recognizes keyboard inputs and pointing device inputs of an operator, output display, files, and directories stored. The operating system on the automated request creation system 102 executes different programs, for example, a web browser, an electronic mail (email) application, a customized program, etc., initiated by the operators of the request creation application 112 using the processor 106. The operating system monitors the use of the processor 106. The processor 106 retrieves the instructions for executing the different modules of the request creation application 112 from the program memory in the form of signals. A program determines the location of the instructions in the program memory. The program stores a number that identifies the current position in the program of the modules, for example, the presentation module 114, the request module 116, the processing and parsing module 118, the mapping module 120, the rate identification module 122, the request creation module 124 and the review module 126 of the request creation application 102.

Network adapters may also be coupled to the system 100 to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The Internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the Internet comprises a vast number of such interconnected networks, computers, and routers. Additionally, client-side software programs that communicate over the Web using the TCP/IP protocol are part of the WWW, such as JAVA® applets, instant messaging, e-mail, browser plug-ins, Macromedia Flash, chat and others. The instant system may be utilized through among other means, text, web, email, messenger and mobile messaging. Other interactive hypertext environments may include proprietary environments such as those provided in America Online or other online service providers, as well as the “wireless Web” provided by various wireless networking providers, especially those in the cellular phone industry. It will be appreciated that the present request creation application 112 could apply in any such interactive communication environments, however, for purposes of discussion, the Web is used as an exemplary interactive hypertext environment with regard to the present request creation application 112.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program, such as Google's Chrome or Apple's Safari, both of which provide a user interface to the world wide web. Upon request from the remote access user via the web browser, the web browser requests the desired hypertext document from the appropriate web server using the URL for the document and the hypertext transport protocol (“HTTP”), a higher-level protocol than TCP/IP designed specifically for the requirements of the world wide web. HTTP runs on top of TCP/IP to transfer hypertext documents and user-supplied form data between server and client computers.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 106, except for a transitory, propagating signal. The computer program product disclosed herein comprises one or more computer program codes for automating the request creation utilizing the automated request creation system 102.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD. Input/output or I/O devices (including but not limited to keyboards, displays, pointing devices, etc.) may be coupled to the system 100 either directly or through intervening I/O controllers.

What is claimed is:

1. A system for automating a request creation, the system comprising:
at least one communication device configured to allow a user to provide a plurality of data points including job title, location, start date and end date; and
an automated request creation system in communication with the at least one communication device via a network, the automated request creation system including a request creation server residing on a central computer having a processor installed with a request creation application and coupled with a memory unit integrated with a central database, the automated request creation system comprising:
a presentation module, at the processor, being configured to present a messaging window on the at least one communication device for the user interactions;
a request module, at the processor, being configured to provide a plurality of queries on the messaging window to request the plurality of data points;
a processing and parsing module, at the processor, being configured to receive the plurality of data points from the request module and to process and parse the plurality of data points into user specific configurations and stored in client-specific databases;
a mapping module, at the processor, being configured to provide a plurality of options on the messaging window for selection by the user if multiple matches for the user provided data points are available and to provide updates on a plurality of actions to be taken within a period of time;
a rate identification module, at the processor, being configured to identify the market rates algorithmically for each of the plurality of data points provided by the user, the rate identification module allowing analysis of market rates and confirmation by the user;
a request creation module, at the processor, being configured to create an automated request once the user confirms the plurality of data points; and
a review module, at the processor, being configured to review the user specific configurations based on the plurality of data points before sending the automated request;
whereby the automated request is created by the request creation module when the user confirms the plurality of data points based on the mapping module and the rate identification module.

2. The system of claim 1 wherein the processing and parsing module utilizes a combination of natural language parsing, self-learning and artificial intelligence to parse and process the plurality of data points.

3. The system of claim 1 wherein the plurality of data points is processed using machine learning and natural language parsing to enhance the clarity and efficiency of the user interactions.

4. The system of claim 1 wherein the automated request created is a job request.

5. The system of claim 1 wherein the automated request created is a hiring request.

6. The system of claim 1 wherein the user provides the plurality of data points to the automated request creation system through the at least one communication device via the network.

7. The system of claim 1 wherein the plurality of data points includes job title, location, the start date and the end date.

8. The system of claim 1 wherein the at least one communication device is selected from a group consisting of: a cellular telephone, a smartphone, a wireless-enabled personal digital assistant, a tablet, a personal computer, a notebook and a mobile device.

9. The system of claim 1 wherein the network is a data communication network selected from a group consisting of: Internet, a local area network (LAN), a wide area network (WAN), wired Ethernet, wireless Ethernet and cellular wireless network.

10. A method for automating a request creation utilizing an automated request creation system, the method comprising the steps of:
a) providing a request creation application installed in an automated request creation system which is in communication with at least one communication device via a network;
b) providing a messaging window on the at least one communication device by a presentation module to interact with a user;
c) displaying a plurality of queries on the messaging window in a user friendly manner by a request module to receive a plurality of data points;
d) processing and parsing the plurality of data points into user specific configurations and storing in client-specific databases by a processing and parsing module;
e) providing a plurality of options on the messaging window for selection by the user by a mapping module if multiple matches for the user provided data points are available;
f) identifying the market rates algorithmically for each of the plurality of data points by a rate identification module for analysis and confirmation by the user;
g) creating an automated request once the user confirms the plurality of data points by a request creation module; and
h) reviewing the user specific configurations based on the plurality of data points before sending the automated request by a review module.

11. The method of claim 10 wherein the plurality of data points is processed using machine learning and natural language parsing to enhance the clarity and efficiency of the user interactions.

12. The method of claim 10 wherein the request creation module automatically completes the request utilizing an artificial intelligence engine capable of auto-completing various fields that are not provided by the user.

13. The method of claim 10 wherein the messaging window is displayed on web and mobile interface.

14. The method of claim 10 wherein the network is a data communication network selected from a group consisting of: Internet, a local area network (LAN), a wide area network (WAN), wired Ethernet, wireless Ethernet and cellular wireless network.

15. The method of claim 10 wherein the automated request creation system interacts with the user to receive the plurality of data points based on which the automated request is created.

16. A computer program product comprising computer executable instructions embodied in a non-transitory computer readable storage medium having a computer readable program code embodied therein, the computer readable program code configured to be executed on a computer system to implement a method for automating a request creation utilizing an automated request creation system via a network, the method comprising the steps of:
a) providing a request creation application installed in an automated request creation system, which is in communication with at least one communication device via a network;
b) providing a messaging window on the at least one communication device by a presentation module to interact with a user;
c) displaying a plurality of queries on the messaging window in a user friendly manner by a request module to receive a plurality of data points;
d) processing and parsing the plurality of data points into user specific configurations and storing in client-specific databases by a processing and parsing module;
e) providing a plurality of options on the messaging window for selection by the user by a mapping module if multiple matches for the user provided data points are available;
f) identifying the market rates algorithmically for each of the plurality of data points by a rate identification module for analysis and confirmation by the user;
g) creating an automated request once the user confirms the plurality of data points by a request creation module; and
h) reviewing the user specific configurations based on the plurality of data points before sending the automated request by a review module.

17. The computer program product of claim 16 wherein the plurality of data points is processed using machine learning and natural language parsing.

18. The computer program product of claim 16 wherein the request creation module automatically completes the request utilizing an artificial intelligence engine.

19. The computer program product of claim 16 wherein the mapping module provides updates about a plurality of actions to be taken by the user within a period of time.

20. The computer program product of claim 16 wherein the automated request creation system interacts with the user to receive the plurality of data points based on which the automated request is created.
